(19) United States
(12) Patent Application Publication
(10) Pub. No.: US 2020/0247459 A1
(43) Pub. Date: Aug. 6, 2020

(54) CONTROL DEVICE AND CONTROL METHOD

(71) Applicant: Hiromi Murata, Aichi (JP)

(72) Inventor: Hiromi Murata, Aichi (JP)

(73) Assignee: NIDEC MOBILITY CORPORATION, Aichi (JP)

(21) Appl. No.: 16/782,619

(22) Filed: Feb. 5, 2020

(30) Foreign Application Priority Data
Feb. 5, 2019 (JP) 2019-018974

(51) Int. Cl. B62D 5/04

(52) U.S. Cl. CPC B62D 5/049; H02P 29/024; B62D 5/0487; B62D 5/046

(57) ABSTRACT

A control device includes a first system and a second system being a redundant system for the first system, and controls a device to be controlled. The control device includes a first abnormality detector detecting abnormality of a first-system circuit constituting the first system, and a second abnormality detector detecting abnormality of a second-system circuit constituting the second system. The first abnormality detector detects existence of abnormality of the first-system circuit by comparing the detected value of a first predetermined part of the first-system circuit with a first threshold. The second abnormality detector detects existence of abnormality of the second-system circuit by comparing the detected value of a second predetermined part in the second-system circuit corresponding to the first predetermined part, with a second threshold different from the first threshold.

### CROSS-REFERENCE TO RELATED APPLICATION

This application is based on Japanese Patent Application No. 2019-018974 filed with the Japan Patent Office on Feb. 5, 2019, the entire contents of which are incorporated herein by reference.

### FIELD

The present invention relates to a control device and a control method, and more particularly to a control device having a redundant system and a control method thereof.

### BACKGROUND

Conventionally, a technique related to a control device that has a redundant system and continues control even when abnormality occurs is known. For example, JP 2018-128429 A discloses a rotation detector that can appropriately monitor abnormality of rotation information of a motor. This rotation detector includes two systems of rotation detection units and control units for monitoring and controlling rotation of the motor. The rotation detection unit of each system includes two sensor elements for detecting rotation of the motor, and monitors abnormality of the sensor elements by self-diagnosis. The control units detect abnormality in the rotation detection units according to information included in output signals output from the rotation detection units of the two systems.

However, even if redundancy is achieved and two systems are provided, if each system is designed to have an identical same stop condition, it is possible that the two systems will simultaneously stop due to an identical cause in one abnormal event. For example, in a case of stopping a system on condition that the voltage at a predetermined part is higher than or equal to a threshold, the system stops when the voltage becomes higher than or equal to the threshold due to occurrence of disturbance (noise). If the respective systems are designed to have an identical stop condition, the systems will stop simultaneously.

### SUMMARY

The present invention has been devised in view of such circumstances, and provides a control device and a control method that prevent a plurality of redundant systems from simultaneously stopping due to a common cause.

In order to solve the above problem, a control device is provided including a first system and a second system that is a redundant system for the first system, the control device controlling a device to be controlled. The control device includes a first abnormality detector configured to detect abnormality of a first-system circuit that constitutes the first system, and a second abnormality detector configured to detect abnormality of a second-system circuit that constitutes the second system. The first abnormality detector detects existence of abnormality of the first-system circuit by comparing a detected value of a first predetermined part of the first system circuit with a first threshold. The second abnormality detector detects existence of abnormality of the second-system circuit by comparing a detected value of a second predetermined part in the second-system circuit, the second predetermined part corresponding to the first predetermined part, with a second threshold different from the first threshold.

According to this, it is possible to set thresholds for detecting abnormality of sensors to values different between the systems. Therefore, it is possible to provide a control device that prevents the systems from simultaneously stopping.

Furthermore, the first-system circuit may include a first predetermined part detector configured to detect a detected value of the first predetermined part. The second-system circuit may include a second predetermined part detector configured to detect a detected value of the second predetermined part. The detected value of the first predetermined part of the first-system circuit may be a voltage value detected by the first predetermined part detector. The detected value of the second predetermined part of the second-system circuit may be a voltage value detected by the second predetermined part detector.

According to this, it is possible to set thresholds for detecting abnormality of sensors to values different between the systems. Therefore, it is possible to provide a control device that prevents the systems from simultaneously stopping.

Furthermore, the first-system circuit may include a first predetermined part detector configured to detect a detected value of the first predetermined part. The second-system circuit may include a second predetermined part detector configured to detect a detected value of the second predetermined part. The first predetermined part detector may be configured of a first-first predetermined part detector and a first-second predetermined part detector redundant for the first-first predetermined part detector. The second predetermined part detector may be configured of a second-first predetermined part detector and a second-second predetermined part detector redundant for the second-first predetermined part detector. The first abnormality detector may detect existence of abnormality of the first predetermined part detector according to whether or not a difference between a detected value of the first-first predetermined part detector and a detected value of the first-second predetermined part detector is less than the first threshold. The second abnormality detector may detect existence of abnormality of the second predetermined part detector according to whether or not a difference between a detected value of the second-first predetermined part detector and a detected value of the second-second predetermined part detector is less than the second threshold.

According to this, it is possible to provide a control device whose reliability is improved by providing the redundant sensors for each system and in which thresholds for detecting abnormality of the sensor differ between the systems so as to prevent the systems from simultaneously stopping.

Furthermore, the first-system circuit may include a first output unit that performs an output to an outside. The second-system circuit may include a second output unit that is redundant for the first output unit. The first predetermined part of the first-system circuit may be a predetermined part of the first output unit. The second predetermined part of the second-system circuit, the second predetermined part being identical to the first predetermined part, may be a predetermined part of the second output unit.

According to this, since the redundant output units which perform an output to the outside of the system circuits are provided, it is possible to provide redundant external systems.

In order to solve the above problem, a control method is provided including a first system and a second system that is a redundant system for the first system, the control method controlling a device to be controlled. The control method includes detecting existence of abnormality of the first system by comparing a detected value of a first predetermined part of the first system with a first threshold, and detecting existence of abnormality of the second system by comparing a detected value of a second predetermined part of the second system, the second predetermined part corresponding to the first predetermined part, with a second threshold different from the first threshold.

According to this, by setting thresholds for detecting abnormality of sensors to values different between the systems, it is possible to provide a control method that prevents the systems from simultaneously stopping.

As described above, according to the present invention, it is possible to provide a control device and a control method capable of preventing a plurality of redundant systems from stopping simultaneously due to a common cause.

### BRIEF DESCRIPTION OF THE DRAWINGS

FIG. 1 is a block configuration diagram of a control device according to a first embodiment of the present invention;

FIG. 2 is a flowchart of the control device according to the first embodiment of the present invention; and

FIG. 3 is a flowchart of a control device according to modification of the first embodiment of the present invention.

### DETAILED DESCRIPTION

An embodiment according to the present invention will be described below with reference to the drawings.

### First Embodiment

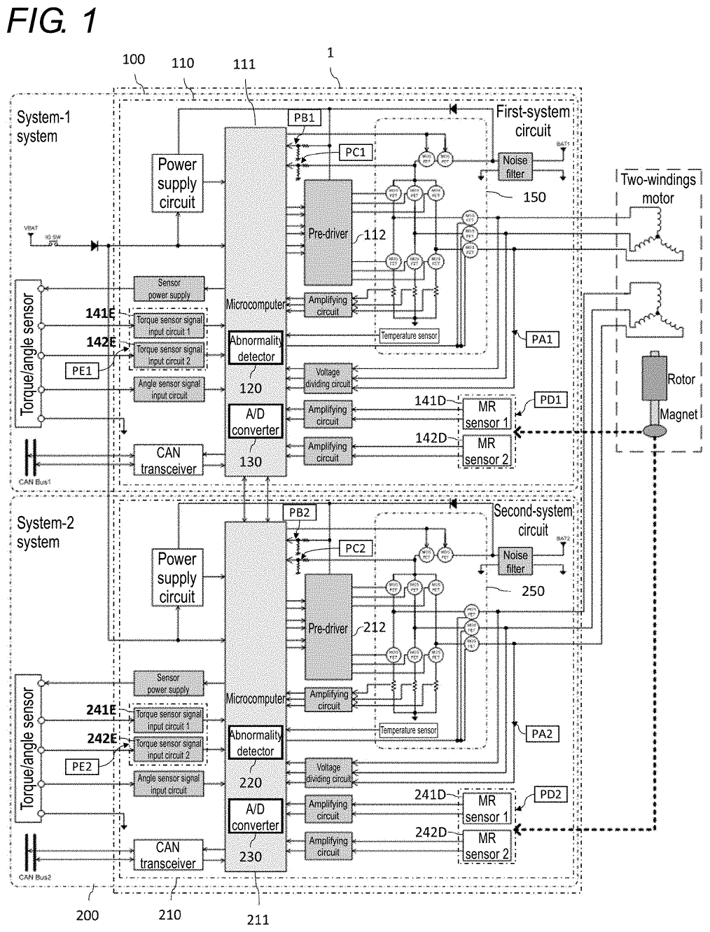

With reference to FIG. 1, a control device 1 in an embodiment will be described. The control device 1 is a control device for controlling a three-phase electric motor (device to be controlled) used for electric power steering mounted on a vehicle. The three-phase electric motor is a motor that has two windings for one rotor and has a doubly redundant system. The three-phase electric motor is not limited to this, and may be a motor having a doubly redundant system by using two motors each having one winding for one rotor. Examples of the device to be controlled include, in addition to the three-phase electric motor according to the embodiment, a solenoid valve in an electronically controlled brake (control device) in a redundant system that accompanies computerization of an automobile. In an IT system, examples of the device to be controlled include a converter and an inverter in an uninterruptible power supply (control device), and a hard disk in a server (control device).

The control device 1 includes a redundant system so as to correspond to a motor having a doubly redundant system in order to continue control even if abnormality occurs. The control device 1 includes a first-system circuit 110 corresponding to a system-1 system 100 (first system) corresponding to one winding of the three-phase electric motor, and a second-system circuit 210 corresponding to a system-2 system 200 (second system) corresponding to the other winding. The first-system circuit 110 and the second-system circuit 210 are supplied with power from a common battery VBAT, acquire a steering condition from torque/angle sensors, and drive the three-phase electric motor to generate auxiliary power for power steering.

The first-system circuit 110 includes two torque sensor signal input circuits 141E, 142E that acquire a signal from the torque/angle sensor that detects the torque and the rotation angle of the steering, two MR sensors 141D, 142D that acquire the rotation angle of the rotor of the three-phase electric motor obtained from a magnet provided on a rotary shaft of the rotor, a microcomputer 111 that acquires signals from various predetermined parts including the torque sensor signal input circuits 141E, 142E and the MR sensors 141D, 142D and controls rotation of the three-phase electric motor, a pre-driver 112 that generates a PWM signal from a control signal of the microcomputer 111, and a bridge circuit 150 that drives the three-phase electric motor by using the PWM signal. Note that the MR sensor is a magnetic resistance sensor.

Torque sensors that detect steering torque, which is important information for electric power steering, are provided in a redundant manner. The input circuit to which the torque sensor signals are input are provided in a redundant manner, that is, the torque sensor signal input circuits 141E and 142E are provided. Similarly, the MR sensors 141D, 142D are provided in a redundant manner in order to acquire rotation angle signals of the three-phase electric motor, which is important information for the electric power steering. The output signals from the torque sensor signal input circuits 141E and 142E provided in a redundant manner are designed to be identical. Similarly, the output signals from the MR sensors 141D and 142D provided in a redundant manner are designed to be identical. Similarly, outputs of other parts provided in a redundant manner are designed to be identical. The microcomputer 111 calculates a PWM duty value for turning on and off a semiconductor element provided in each phase circuit of the bridge circuit 150 according to signals obtained from these circuits and the like. The pre-driver 112 outputs a PWM signal for driving the bridge circuit 150 according to the PWM duty value. The bridge circuit 150 functions as an output unit (first output unit) for the three-phase electric motor existing outside the first-system circuit 110, and drives rotation of the three-phase electric motor.

The microcomputer 111 includes a first abnormality detector 120 that detects abnormality of a predetermined part of the first-system circuit 110, and an A/D converter 130 that converts the detected value of the predetermined part into a digital value in a case where the detected value is an analog value. Examples of the predetermined part of the first-system circuit 110 include a terminal (PA1) of the three-phase electric motor, a terminal (PB1) of a battery BAT1, an output terminal (PC1) of a power relay of the battery BAT1, a location where the MR sensors 141D, 142D (PD1) are mounted on a printed board, and the input side of the torque sensor signal input circuits 141E, 142E (PE1) where an output signal from the torque sensor is input to the control device 1. A voltage is input as a digital value at the terminal (PA1) of the three-phase electric motor. A voltage is input as a digital value at the terminal (PB1) of the battery BAT1. A voltage is input as a digital value at the output terminal (PC1) of the power relay of the battery BAT1. A Sin wave-like voltage and a Cos wave-like voltage that change according to rotation of the three-phase electric motor are input as digital values at the MR sensors 141D, 142D (PD1). Torque applied to the steering is input as a digital value at the torque sensor signal input circuits 141E, 142E (PE1). Note that the terminal (PA1) of the three-phase electric motor is a predetermined part of the output unit. These predetermined parts are examples only, are not limited to them and may be any part as long as the part acquires a detected value in order to detect abnormality in the first-system circuit 110.

The first abnormality detector 120 compares the detected value of the predetermined part of the first-system circuit 110 (first predetermined part) with a predetermined threshold (first threshold) to detect existence of abnormality in the first-system circuit 110. For example, when the first abnormality detector 120 acquires the detected value of the voltage value at the terminal (PA1) of the three-phase electric motor, the first abnormality detector 120 compares the detected value with a threshold determined in advance. The first abnormality detector 120 detects abnormality in the first-system circuit 110, for example, in a case where the detected value exceeds the threshold determined in advance. Similarly, when the first abnormality detector 120 acquires a detected value of the voltage value at the terminal (PB1) of the battery BAT1, the first abnormality detector 120 compares the detected value with a threshold determined in advance. The first abnormality detector 120 detects abnormality in the first-system circuit 110, for example, in a case where the detected value is less than the threshold. In this case, it may not be possible to identify whether the circuit inside the control device 1 is abnormal or the battery is abnormal. It is assumed that the determination that there is abnormality in the first-system circuit 110 includes abnormality in the battery that is outside the control device 1.

The second-system circuit 210 includes two torque sensor signal input circuits 241E, 242E that acquire signals from the torque/angle sensor that detects the torque and the rotation angle of the steering, two MR sensors 241D, 242D that acquire the rotation angle of the rotor of the three-phase electric motor obtained from the magnet provided on the rotary shaft of the rotor, a microcomputer 211 that acquires signals from various predetermined parts including the torque sensor signal input circuits 241E, 242E and the MR sensors 241D, 242D and controls rotation of signals of the three-phase electric motor, a pre-driver 212 that generates a PWM signal from the control signal of the microcomputer 211, and a bridge circuit 250 that drives the three-phase electric motor by using the PWM signal. Since these constituents are identical to the corresponding constituents in the first-system circuit 110 described above, description thereof is omitted.

The second abnormality detector 220 compares the detected value of a predetermined part (second predetermined part) of the second-system circuit 210 with a predetermined threshold (second threshold) different from the predetermined threshold (first threshold) in the first-system circuit 110 to detect existence of abnormality in the second-system circuit 210. For example, when the second abnormality detector 220 acquires a detected value of a voltage value at a terminal (PA2) of the three-phase electric motor in the other winding, the second abnormality detector 220 compares the detected value with a threshold determined in advance different from the predetermined threshold in the first-system circuit 110, and detects abnormality in the second-system circuit 210, for example, in a case where the detected value exceeds the threshold determined in advance. Note that the voltage value at the terminal (PA2) is designed to be identical to the voltage value at the terminal (PB1). Similarly, when the second abnormality detector 220 acquires the detected value of a voltage value at a terminal (PB2) of the battery BAT2, the detected value and a threshold determined in advance different from the predetermined threshold in the first-system circuit 110 are compared with each other. For example, in a case where the detected value is less than the threshold determined in advance, the second abnormality detector 220 detects abnormality in the second-system circuit 210.

For example, in a case where a first threshold determined in advance at the terminal (PA1) of the three-phase electric motor in the first abnormality detector 120 is X volts and the second threshold determined in advance in the terminal (PA2) of the other winding of the three-phase electric motor in the second abnormality detector 220 is Y volts (Y<X), when some disturbance occurs and Z bolts (Y<Z<X) is detected at the terminals PA1 and PA2, only the second abnormality detector 220 detects abnormality and stops driving of the three-phase electric motor. However, since the first abnormality detector 120 does not detect any abnormality, it is possible to continue driving of three-phase electric motor. As described, by setting thresholds for detecting abnormality by two systems provided in a redundant manner to different values, it is possible to provide the control device 1 that prevents simultaneous stop of the two systems.

In addition, the control device 1 acquires a voltage value in the first-system circuit 110 by converting the voltage value at the terminal (PB1) of the battery BAT1 from an analog voltage value to a digital voltage value by the A/D converter 130. The control device 1 acquires a voltage value in the second-system circuit 210 by converting the voltage value at the terminal (PB2) of the battery BAT2 from an analog voltage value to a digital voltage value by an A/D converter 230.

In addition, the control device 1 includes the MR sensors 141D, 142D as a first predetermined part detector, and the MR sensors 241D, 242D as a second predetermined part detector. The MR sensors 141D, 142D are provided in the first-system circuit 110 and detect rotation of the three-phase electric motor. The MR sensors 241D, 242D are provided in the second-system circuit 210 and detect rotation of the three-phase electric motor. In this embodiment, the three-phase electric motor includes two systems of windings of stators. However, the two systems share the rotor and there is one rotor. The MR sensors detect rotation of the rotor as a change in the magnetic field of the magnet formed at a rotor leading end portion. As described, it is preferable that two first predetermined part detectors and two predetermined part detectors for acquiring information necessary for appropriate rotational driving of the three-phase electric motor are provided in each of the system circuits. That is, such an important first predetermined part detector is configured of the MR sensor 141D (first-first predetermined part detector) and the MR sensor 142D (first-second predetermined part detector) redundant for the MR sensor 141D. In addition, similarly, the second predetermined part detector is configured of the MR sensor 241D (second-first predetermined part detector) and the MR sensor 242D (second-second predetermined part detector) redundant for the MR sensor 241D.

As described, in a case where the redundant MR sensors are provided in each system, the first abnormality detector 120 detects existence of abnormality of the first predetermined part detector according to whether or not the difference between the detected value of the MR sensor 141D (first-first predetermined part detector) and the detected value of the MR sensor 142D (first-second predetermined part detector) is less than a predetermined threshold (first threshold). In addition, similarly, the second abnormality detector 220 detects existence of abnormality of the second predetermined part detector according to whether or not the difference between the detected value of the MR sensor 241D (second-first predetermined part detector) and the detected value of the MR sensor 242D (second-second predetermined part detector) is less than a predetermined threshold (second threshold).

In addition, the control device 1 includes the torque sensor signal input circuits 141E, 142E as the first predetermined part detector, and the torque sensor signal input circuits 241E, 242E as the second predetermined part detector. The torque sensor signal input circuits 141E, 142E are provided in the first-system circuit 110 and acquire torque of the steering from the torque/angle sensor. The torque sensor signal input circuits 241E, 242E are provided in the second-system circuit 210 and acquire torque of the steering from the torque/angle sensor. That is, such an important first predetermined part detector is configured of the torque sensor signal input circuit 141E (first-first predetermined part detector) and the torque sensor signal input circuit 142E (first-second predetermined part detector) redundant for the torque sensor signal input circuit 141E. In addition, similarly, the second predetermined part detector is configured of the torque sensor signal input circuit 241E (second-first predetermined part detector) and the torque sensor signal input circuit 242E (second-second predetermined part detector) redundant for the torque sensor signal input circuit 241E.

As described, in a case where the redundant torque sensor signal input circuit are provided in each system, the first abnormality detector 120 detects existence of abnormality of the first predetermined part detector according to whether or not the difference between the detected value of the torque sensor signal input circuit 141E (first-first predetermined part detector) and the detected value of the torque sensor signal input circuit 142E (first-second predetermined part detector) is less than a predetermined threshold (first threshold). Abnormality of the first predetermined part detector includes abnormality of the torque sensor itself in addition to abnormality of the torque sensor signal input circuit itself. In addition, similarly, the second abnormality detector 220 detects existence of abnormality of the second predetermined part detector according to whether or not the difference between the detected value of the torque sensor signal input circuit 241E (second-first predetermined part detector) and the detected value of the torque sensor signal input circuit 242E (second-second predetermined part detector) is less than a predetermined threshold (second threshold).

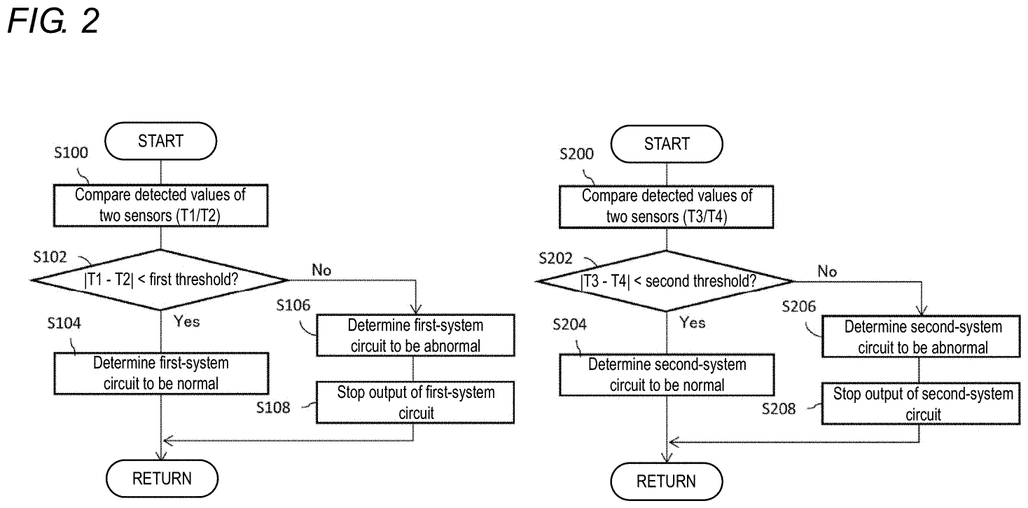

Here, with reference to FIG. 2, the control flow of the control device 1 in a case where, for example, the redundant MR sensors are provided in each system will be described. In S100, the microcomputer 111 of the first-system circuit 110 acquires signals from the two MR sensors 141D and 142D, and calculates the rotation angles (T1 and T2) of the three-phase electric motor. Then, the microcomputer 111 compares T1 and T2. In a case where the microcomputer 111 determines, in S102, that the absolute value of the difference between T1 and T2 is less than the predetermined threshold (first threshold), the microcomputer 111 determines, in S104, that the first-system circuit 110 is normal. In contrast, in a case where the microcomputer 111 determines, in S102, that the absolute value of the difference between T1 and T2 is greater than or equal to the predetermined threshold (first threshold), the microcomputer 111 determines, in S106, that the first-system circuit 110 is abnormal. In S108, the microcomputer 111 stops output of the first-system circuit 110, that is, causes the bridge circuit 150 to stop rotational driving of the three-phase electric motor.

In S200, the microcomputer 211 of the second-system circuit 210 acquires signals from the two MR sensors 241D and 242D, and calculates the rotation angles (T3 and T4) of the three-phase electric motor. Then, the microcomputer 211 compares T3 and T4. In a case where the microcomputer 211 determines, in S202, that the absolute value of the difference between T3 and T4 is less than the predetermined threshold (second threshold # first threshold), the microcomputer 211 determines, in S204, that the second-system circuit 210 is normal. In contrast, in a case where the microcomputer 211 determines, in S202, that the absolute value of the difference between T3 and T4 is greater than or equal to the predetermined threshold (second threshold), the microcomputer 211 determines, in S206, that the second-system circuit 210 is abnormal. In S208, the microcomputer 211 stops the output of the second-system circuit 210, that is, causes the bridge circuit 250 to stop rotational driving of the three-phase electric motor. As described, by setting thresholds for detecting abnormality to be different between the two sensors provided in a redundant manner, it is possible to avoid the situation where the two sensors are determined to be abnormal simultaneously.

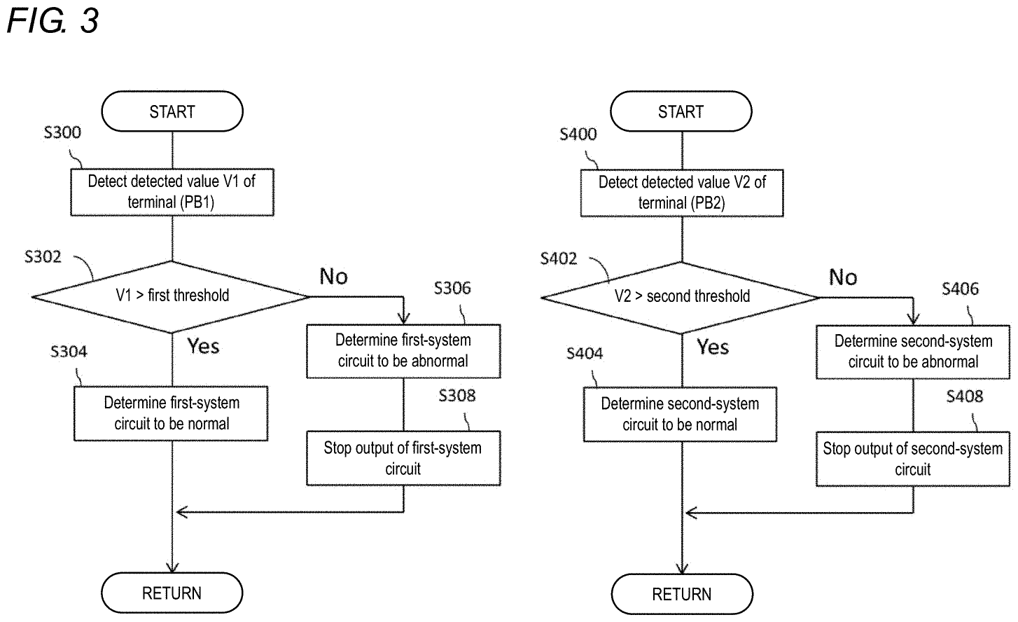

Here, a modification of the control flow described above will be described with reference to FIG. 3. In S300, the microcomputer 111 of the first-system circuit 110 acquires a detected value V1 of the terminal (PB1) of the battery BAT1. In S302, the microcomputer 111 compares the detected value V1 with a predetermined threshold (first threshold). In a case where the microcomputer 111 determines, in S302, that the detected value V1 of exceeds the predetermined threshold (first threshold), the microcomputer 111 determines, in S304, that the first-system circuit 110 is normal. In contrast, in a case where the microcomputer 111 determines, in S302, that the detected value V1 is less than or equal to the predetermined threshold (first threshold), the microcomputer 111 determines, in S306, that the first-system circuit 110 is abnormal. In S308, the microcomputer 111 stops output of the first-system circuit 110, that is, causes the bridge circuit 150 to stop rotational driving of the three-phase electric motor.

In addition, in S400, the microcomputer 211 of the second-system circuit 210 acquires a detected value V2 of the terminal (PB2) of the battery BAT2. In S402, the microcomputer 211 compares the detected value V2 with a predetermined threshold (second threshold # first threshold). In a case where the microcomputer 211 determines, in S402, that the detected value V2 exceeds the predetermined threshold (second threshold), the microcomputer 211 determines, in S404, that the second-system circuit 210 is normal. In a case where the microcomputer 211 determines, in S402, that the detected value V2 is less than or equal to the predetermined threshold (second threshold), the microcomputer 211 determines, in S406, that the second-system circuit 210 is abnormal. In S408, the microcomputer 211 stops output of the second-system circuit 210, that is, causes the bridge circuit 250 to stop rotational driving of the three-phase electric motor. As described, by setting thresholds for detecting abnormality of a detected value to be different between corresponding parts in the two systems provided in a redundant manner, it is possible to avoid the situation where the sensors are determined to be abnormal simultaneously.

As described, in the control device 1, the microcomputers 111 and 211 belonging to the respective systems rotationally drive the three-phase electric motor according to the detected values input to the microcomputers 111 and 211, respectively, and detect abnormality in the constituents of the respective systems according to different criteria. As a result, the control device 1 can avoid simultaneous stopping of the systems.

In addition, what has been described above is a control method including the first system and the second system that is a redundant system for the first system and controlling a device to be controlled. This control method includes the first-system circuit 110 (first system) and the second-system circuit 210 (second system) for the first-system circuit 110, and controls the three-phase electric motor. In the first-system circuit 110, the detected value of the predetermined part (first predetermined part) such as the terminal (PB1) of the battery BAT1 is compared with the threshold determined in advance (first threshold) to detect existence of abnormality in the first-system circuit 110. In the second-system circuit 210, the detected value of the terminal (PB2) of the battery BAT2 corresponding to the terminal (PB1) of the battery BAT1 is compared with the threshold determined in advance (second threshold) different from the first threshold to detect existence of abnormality in the second-system circuit 210. According to this, by setting thresholds for detecting abnormality of sensors to values different between the systems, it is possible to provide a control method that prevents the systems from simultaneously stopping.

As a way of thinking the first threshold and the second threshold, for example, one is a value for preventing a dangerous event such as an ignition or an accident, and the other is a value for preventing a performance degradation. Alternatively, one is a value for preventing an unrecoverable event and the other is a value for preventing a recoverable event. Events that occur in a case where abnormality is left unattended may be divided into two levels in terms of hazard, danger, comfort, or the like, and thresholds that can prevent occurrence of respective events may be set.

Note that the present invention is not limited to the embodiment described as an example, and may be implemented with the structure within the scope not deviating from the content described in each item of the claims. That is, although the present invention has been particularly illustrated and described with respect to the particular embodiment, it should be understood that those skilled in the art can make various modifications to the embodiment described above in terms of quantity and another detailed configuration without departing from the scope of the technical idea and the object of the present invention.

For example, in the above-described embodiment, the first-system circuit 110 and the second-system circuit 210 include the microcomputers 111, 211, the pre-drivers 112, 212, and the bridge circuits 150, 250, respectively. However, the present invention is not limited to this. For example, only one microcomputer may be provided, and pre-drivers 112, 212 and bridge circuits 150, 250 may be provided in a redundant manner. As described, output units which perform an output to the outside of a system circuit are provided in a redundant manner, so that external systems can be provided in a redundant manner.

1. A control device comprising a first system and a second system that is a redundant system for the first system, and controlling a device to be controlled, the control device comprising:
a first abnormality detector configured to detect abnormality of a first-system circuit that constitutes the first system; and
a second abnormality detector configured to detect abnormality of a second-system circuit that constitutes the second system,
wherein the first abnormality detector detects existence of abnormality of the first-system circuit by comparing a detected value of a first predetermined part of the first-system circuit with a first threshold, and
wherein the second abnormality detector detects existence of abnormality of the second-system circuit by comparing a detected value of a second predetermined part in the second-system circuit, the second predetermined part corresponding to the first predetermined part, with a second threshold different from the first threshold.

2. The control device according to claim 1,
wherein the first-system circuit includes a first predetermined part detector configured to detect a detected value of the first predetermined part,
wherein the second-system circuit includes a second predetermined part detector configured to detect a detected value of the second predetermined part,
wherein the detected value of the first predetermined part of the first-system circuit is a voltage value detected by the first predetermined part detector, and
wherein the detected value of the second predetermined part of the second-system circuit is a voltage value detected by the second predetermined part detector.

3. The control device according to claim 1,
wherein the first-system circuit includes a first predetermined part detector configured to detect a detected value of the first predetermined part,
wherein the second-system circuit includes a second predetermined part detector configured to detect a detected value of the second predetermined part,
wherein the first predetermined part detector is configured of a first-first predetermined part detector and a first-second predetermined part detector that is redundant for the first-first predetermined part detector,
wherein the second predetermined part detector is configured of a second-first predetermined part detector and a second-second predetermined part detector that is redundant for the second-first predetermined part detector,
wherein the first abnormality detector detects existence of abnormality of the first predetermined part detector according to whether or not a difference between a detected value of the first-first predetermined part detector and a detected value of the first-second predetermined part detector is less than the first threshold, and
wherein the second abnormality detector detects existence of abnormality of the second predetermined part detector according to whether or not a difference between a detected value of the second-first predetermined part detector and a detected value of the second-second predetermined part detector is less than the second threshold.

4. The control device according to claim 1,
wherein the first-system circuit includes a first output unit that performs an output to an outside,
wherein the second-system circuit includes a second output unit that is redundant for the first output unit,
wherein the first predetermined part of the first-system circuit is a predetermined part of the first output unit, and
wherein the second predetermined part of the second-system circuit, the second predetermined part being identical to the first predetermined part, is a predetermined part of the second output unit.

5. A control method comprising a first system and a second system that is a redundant system for the first system, the control method controlling a device to be controlled, the control method comprising:
detecting existence of abnormality of the first system by comparing a detected value of a first predetermined part of the first system with a first threshold; and
detecting existence of abnormality of the second system by comparing a detected value of a second predetermined part of the second system, the second predetermined part corresponding to the first predetermined part, with a second threshold different from the first threshold.
